(19) United States
(12) Patent Application Publication
(10) Pub. No.: US 2026/0113524 A1
(43) Pub. Date: Apr. 23, 2026

(54) CAMERA MODULE

(71) Applicant: Samsung Electro-Mechanics Co., Ltd., Suwon-si (KR)

(72) Inventors: Daseul KIM, Suwon-si (KR); Taewon KANG, Suwon-si (KR); Janghun KIM, Suwon-si (KR); Jaegyeong JIN, Suwon-si (KR)

(73) Assignee: Samsung Electro-Mechanics Co., Ltd., Suwon-si (KR)

(21) Appl. No.: 19/078,455

(22) Filed: Mar. 13, 2025

(30) Foreign Application Priority Data
Oct. 18, 2024 (KR) 10-2024-0142845

(51) Int. Cl. H04N 23/54; H04N 23/55

(52) U.S. Cl. CPC H04N 23/54; H04N 23/55

(57) ABSTRACT

A camera module includes a lens barrel; an image sensor disposed on one side of the lens barrel in an optical axis direction of the lens barrel; a substrate electrically connected to the image sensor; and a reinforcing member, comprising a rigid reinforcing portion, disposed to support the substrate. The rigid reinforcing portion comprises a plurality of rigid reinforcing lines intersecting each other at at least one point.

### CROSS-REFERENCE TO RELATED APPLICATIONS

This application claims the benefit under 35 USC 119(a) of Korean Patent Application No. 10-2024-0142845 filed on Oct. 18, 2024, in the Korean Intellectual Property Office, the entire disclosure of which is incorporated herein by reference for all purposes.

### BACKGROUND

### 1. Field

The present disclosure relates to a camera module.

### 2. Description of the Background

The size of components mounted on electronic devices are miniaturized, driven by the trend towards slimmer portable electronic devices like mobile phones that includes camera modules.

Portable smartphone camera modules used for video recording may use high-performance camera modules, e.g., in vehicles to implement cutting-edge advanced driver-assistance systems (ADAS) for autonomous driving functions.

However, as camera modules become miniaturized and have higher resolution, there is an increased risk of the camera module being damaged by external force.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a camera module includes a lens barrel; an image sensor disposed on one side of the lens barrel in an optical axis direction of the lens barrel; a substrate electrically connected to the image sensor; and a reinforcing member, comprising a rigid reinforcing portion, disposed to support the substrate. The rigid reinforcing portion comprises a plurality of rigid reinforcing lines intersecting each other at at least one point.

The reinforcing member may further include a first region, and a second region disposed in a central region of the first region. The rigid reinforcing portion may be disposed in the second region.

A longitudinal direction of the rigid reinforcing line may pass through a central region of the second region and face an edge of the second region.

The longitudinal direction of the plurality of rigid reinforcing lines may be disposed parallel to one side of a boundary between the first region and the second region.

Two of the plurality of rigid reinforcing lines may intersect each other in a central region of the second region.

The plurality of rigid reinforcing lines may include a first rigid reinforcing line in which the longitudinal direction passes through the central region of the second region and faces the edge of the second region, and a second rigid reinforcing line in which the longitudinal direction is disposed parallel to one side of the second region.

The second rigid reinforcing line may include a plurality of second rigid reinforcing lines disposed to intersect each other in the central region of the second region.

The plurality of rigid reinforcing lines may include a first rigid line in which the longitudinal direction from a first side of the second region to a third side of the second region faces the first side, and a second rigid line in which the longitudinal direction from a second side of the second region to a fourth side of the second region faces the second side.

The plurality of rigid reinforcing lines may include a first rigid line in which the longitudinal direction from a first side of the second region to a third side of the second region faces the first side, and a second rigid line in which the longitudinal direction is inclined with respect to the longitudinal direction of the first rigid reinforcing line, and one end of the longitudinal direction of the second rigid line faces an edge of the second region.

An opening may extend from a surface in the central region of the substrate facing the second region in the direction of the optical axis.

In one general aspect, a camera module includes a lens barrel; an image sensor disposed on one side of the lens barrel in an optical axis direction of the lens barrel; a substrate electrically connected to the image sensor; and a reinforcing member, comprising a rigid reinforcing portion, disposed to support the substrate. The rigid reinforcing portion is recessed away from the substrate, and a thickness of the reinforcing member corresponds to a thickness of the rigid reinforcing portion and other regions of the reinforcing member.

The rigid reinforcing portion may include a plurality of rigid reinforcing lines intersecting each other at at least one point.

In another general aspect, a camera module includes a lens barrel; an image sensor disposed on one side of the lens barrel in an optical axis direction of the lens barrel; a substrate electrically connected to the image sensor; and a reinforcing member, comprising a rigid reinforcing portion, disposed to support the substrate. The rigid reinforcing portion protrudes toward the substrate more than an adjacent region, and a thickness of the reinforcing member corresponds to a thickness of the rigid reinforcing portion and other regions of the reinforcing member.

The rigid reinforcing portion may include a plurality of rigid reinforcing lines intersecting each other at at least one point.

Other features and aspects will be apparent from the following detailed description, the drawings, and the claims.

### BRIEF DESCRIPTION OF DRAWINGS

FIG. 1 is an exploded perspective view of a camera module according to an embodiment.

FIG. 2 is a drawing of a substrate and a reinforcing member viewed from the top to the bottom in the optical axis direction with light traveling therethrough.

FIG. 3 is a top-plan view of a reinforcing member.

FIG. 4 is a cross-sectional view taken along line A-A′ of FIG. 3.

FIG. 5 is a cross-sectional view of a reinforcing member according to another embodiment.

FIG. 6 is a top-plan view of a reinforcing member according to another embodiment.

FIG. 7 is a top-plan view of a reinforcing member according to another embodiment.

FIG. 8 is a top-plan view of a reinforcing member according to another embodiment.

FIG. 9 is a top-plan view of a reinforcing member according to another embodiment.

FIG. 10 is a top-plan view of a reinforcing member according to another embodiment.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to”another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

The present disclosure will be described in detail hereinafter with reference to the accompanying drawings, in which embodiments of the present disclosure are shown. As those skilled in the art would realize, the described embodiments may be modified in various different ways, all without departing from the spirit or scope of the present disclosure.

In addition, the phrase “on a plane” means a view from a position above the object (e.g., from the top), and the phrase “in a cross-section” means a view of a cross-section of the object which is vertically cut from the side.

Hereinafter, an optical axis OA direction, which is a direction parallel to the central axis of a lens accommodated in a lens barrel 10, may mean the z-axis direction in the drawings. Also, the direction intersecting the optical axis OA direction may mean the x-axis direction in the drawings, and the direction intersecting the optical axis OA direction and the x-axis direction may mean the y-axis direction of the drawings. For example, the z-axis, x-axis, and y-axis may be orthogonal to each other.

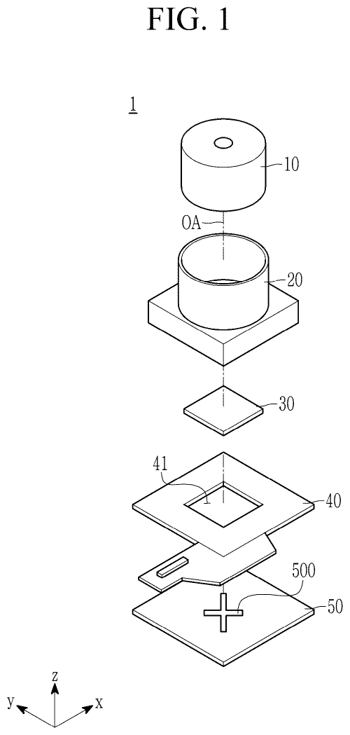

FIG. 1 is an exploded perspective view of a camera module 1 according to an embodiment.

Referring to FIG. 1, the camera module 1 according to an embodiment may include the lens barrel 10, a housing 20, an image sensor 30, a substrate 40, and a reinforcing member 50.

The lens barrel 10 may accommodate at least one lens therein. The lens barrel 10 may have a hollow cylindrical shape so that at least one lens for photographing a subject may be accommodated therein. When lenses are provided in plurality, the plurality of lenses may be mounted on the lens barrel 10 in the optical axis OA (z-axis in the drawings). The plurality of lenses may be arranged in a desired number based on the design of the lens barrel 10, and each lens may have optical characteristics such as the same or a different refractive index.

The housing 20 may accommodate the lens barrel 10 therein. For example, the housing 20 may have a structure in which the upper portion and the lower portion are open. The housing 20 may function to protect the internal components of the camera module 1. In addition, the housing 20 may function to shield electromagnetic waves generated from the camera module 1 so that the electromagnetic waves do not affect other electronic components. The substrate 40 on which the image sensor 30 is mounted may be located at the bottom of the housing 20.

The image sensor 30 may be disposed on one side of the lens barrel 10 in the direction of the optical axis OA of the lens barrel 10. The image sensor 30 may convert incident light that has passed through the lens into an electrical signal. For example, the image sensor 30 may be a charge-coupled device (CCD), a complementary metal-oxide semiconductor (CMOS), etc. The electrical signal converted by the image sensor 30 may be output as an image through a display unit of an electronic device such as a smartphone. The image sensor 30 may be mounted on the substrate 40.

The image sensor 30 may be electrically connected to the substrate 40. For example, the image sensor 30 may be directly connected to the substrate 40 by wire bonding or the like. Each of both ends of the wire may be attached to a connection terminal of the image sensor 30 and a connection terminal of the substrate 40.

One end of the substrate 40 may have a structure extending to the outside of the housing 20 to be connected to an external circuit. The substrate 40 may be a flexible printed circuit board (FPCB), etc. For example, the substrate 40 may be any one of the flexible resin substrates such as polyimide, a rigid-flexible PCB (RFPCB), or a two-layered FPCB, but is not limited thereto.

The substrate 40 may have an opening 41 in the central region. The opening 41 is provided to penetrate both surfaces of the substrate 40. Accordingly, spaces located on both surfaces of the substrate 40 in the direction of the optical axis OA through the opening 41 may be connected to each other. The opening 41 may have a shape corresponding to the image sensor 30. The area of the opening 41 may be provided to be equal to or greater than the area of the image sensor 30. Accordingly, the image sensor 30 may be disposed in the opening 41.

After the image sensor 30 is disposed in the opening 41 of the substrate 40, the image sensor 30 and the substrate 40 are electrically connected, thereby maximizing space efficiency and reducing the size of the camera module 1.

The reinforcing member 50 may be disposed on one side of the substrate 40. The reinforcing member 50 may be disposed on the opposite side of the lens barrel 10 based on the substrate 40. In the optical axis OA direction, the reinforcing member 50 may be disposed below the substrate 40. The reinforcing member 50 may be bonded to the substrate 40. The reinforcing member 50 may support the substrate 40 and prevent the substrate 40 from being deformed or damaged by external force.

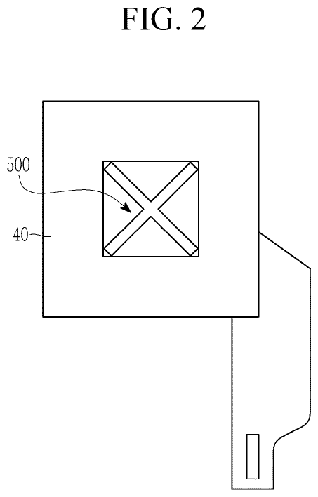

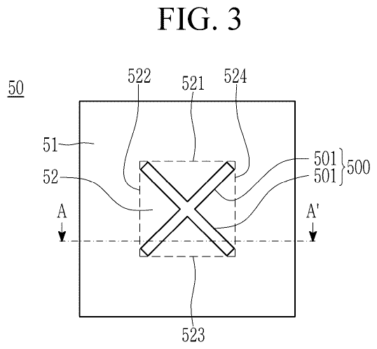

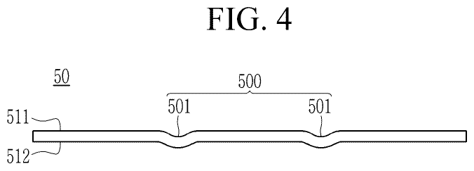

FIG. 2 is a drawing of the substrate 40 and the reinforcing member 50 viewed from the top to bottom in the optical axis OA direction with light traveling therethrough. FIG. 3 is a top-plan view of the reinforcing member 50, and FIG. 4 is a cross-sectional view along line A-A′ of FIG. 3.

Referring to FIGS. 2 to 4, a rigid reinforcing portion 500 may be positioned on the reinforcing member 50. For example, the rigid reinforcing portion 500 may be provided so as to be recessed downwardly from the adjacent region. That is, when viewed from top to bottom in the optical axis OA direction, the rigid reinforcing portion 500 may be provided to be recessed in the opposite direction of the substrate 40 more than the adjacent region. Additionally, when viewed from bottom to top in the optical axis OA direction, the rigid reinforcing portion 500 may be provided to protrude in the opposite direction of the substrate 40 more than the adjacent region. The reinforcing member 50 may include a first surface 511 and a second surface 512. The first surface 511 may face the substrate 40. The second surface 512 may be positioned on the opposite side of the substrate 40. Additionally, the rigid reinforcing portion 500 may be recessed in the first surface 511, and protruded in the second surface 512.

For example, the reinforcing member 50 may be provided from a metallic material such as SUS. Additionally, the rigid reinforcing portion 500 may be formed through press processing. Accordingly, the thickness of the reinforcing members 50 in the optical axis OA direction may correspond to the thickness of the rigid reinforcing portion 500 and other regions than the rigid reinforcing portion 500.

The reinforcing member 50 may include a first region 51 and a second region 52. The second region 52 may be positioned in the inner region of the first region 51. That is, the first region 51 may be positioned on the outer periphery of the second region 52. For example, a first side 521, a second side 522, a third side 523, and a fourth side 524 may be positioned at the boundary between the first region 51 and the second region 52. Both ends of the first side 521 are connected to one end of the second side 522 and one end of the fourth side 524, respectively. Both ends of the third side 523 are connected to the other ends of the second side 522 and the fourth side 524, respectively. The first side 521 faces the third side 523. The second side 522 faces the fourth side 524.

If the substrate 40 is disposed on the reinforcing member 50, the first region 51 of the first surface 511 may face one surface of the substrate 40 in the optical axis OA direction. If the substrate 40 is disposed on the reinforcing member 50, the second region 52 of the first surface 511 may face the opening 41 in the optical axis OA direction. Accordingly, when the image sensor 30 is not present, the second region 52 of the first surface 511 may be exposed through the opening 41. And when the image sensor 30 is connected to the substrate 40, the image sensor 30 may be disposed in the second region 52 of the first surface 511.

The rigid reinforcing portion 500 may be positioned in the second region 52. The rigid reinforcing portion 500 may include a plurality of rigid reinforcing lines 501. Each of the rigid reinforcing lines 501 may be provided so as to be recessed downwardly from the adjacent region. That is, when viewed from top to bottom in the optical axis OA, the rigid reinforcing lines 501 may be provided to be recessed in the opposite direction of the substrate 40 more than the adjacent region. Additionally, when viewed from bottom to top in the optical axis OA, the rigid reinforcing lines 501 may be provided to protrude in the opposite direction of the substrate 40 more than the adjacent region.

Each of the rigid reinforcing lines 501 may have a straight-line structure. The plurality of rigid reinforcing lines 501 may be positioned to intersect each other at at least one point. For example, the longitudinal direction of each of the rigid reinforcing lines 501 may be provided so as to pass through the central region of the second region 52 and toward the edge of the second region 52. That is, the longitudinal direction of each of the rigid reinforcing lines 501 may extend from the edge where the first side 521 and the fourth side 524 meet to the edge where the second side 522 and the third side 523 meet. Additionally, the longitudinal direction of the rigid reinforcing lines 501 may extend from the edge where the first side 521 and the second side 522 meet to the edge where the third side 523 and the fourth side 524 meet. Two rigid reinforcing lines 501 may intersect each other in the central region of the second region 52.

Additionally, both ends of each of the rigid reinforcing lines 501 may be positioned adjacent to the edges of the second region 52. That is, the length of each of the rigid reinforcing lines 501 may correspond to the length of the distance between the edges of the second region 52 that face each other in a diagonal direction passing through the central region of the second region 52.

The rigid reinforcing portion 500 may strengthen the rigidity of the reinforcing member 50.

The rigid reinforcing portion 500 may reduce deformation of the shape of the reinforcing member 50 caused by a force that causes distortion or bending of the reinforcing member 50. Accordingly, when a force is applied to the substrate 40 or the image sensor 30 in the optical axis OA direction, the shape deformation of the second region 52 and the image sensor 30 disposed in the second region 52 may be minimized by the reinforcing member 50 with the rigid reinforcing portion 500. Accordingly, the image sensor 30 may be prevented from being bent and damaged by an external force.

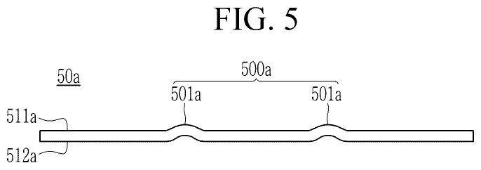

FIG. 5 is a cross-sectional view of a reinforcing member 50a according to another embodiment.

Referring to FIG. 5, a rigid reinforcing portion 500a may be positioned on the reinforcing member 50a. For example, the rigid reinforcing portion 500a may be provided to protrude upwardly above the adjacent region. That is, when viewed from the top to the bottom in the optical axis OA direction, the rigid reinforcing portion 500a may be provided to protrude toward the substrate 40 more than the adjacent region. Additionally, when viewed from the bottom to the top in the optical axis OA direction, the rigid reinforcing portion 500a may be provided to be recessed toward the substrate 40 more than the adjacent region. The reinforcing member 50a may include a first surface 511a and a second surface 512a. The first surface 511a may face the substrate 40. The second surface 512a may be positioned on the opposite side of the substrate 40. The rigid reinforcing portion 500a may protrude from the first surface 511a and be recessed in the second surface 512a.

For example, the reinforcing member 50a may be provided from a metallic material such as SUS. Also, the rigid reinforcing portion 500a may be formed through press processing. Accordingly, the thicknesses of the reinforcing member 50a in the optical axis OA direction may correspond to each other on the rigid reinforcing portion 500a and in regions other than the rigid reinforcing portion 500a.

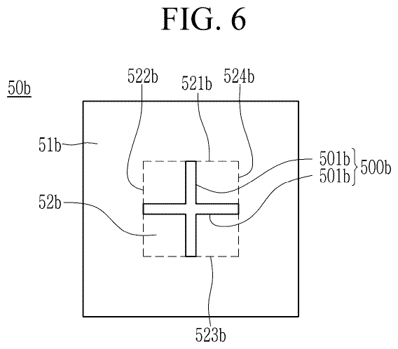

FIG. 6 is a top plan view of a reinforcing member 50b according to another embodiment.

Referring to FIG. 6, a rigid reinforcing portion 500b may be positioned on the reinforcing member 50b. The reinforcing member 50b may include a first region 51b and a second region 52b. The second region 52b may be positioned in the inner region of the first region 51b. That is, the first region 51b may be positioned on the outer periphery of the second region 52b. For example, a first side 521b, a second side 522b, a third side 523b, and a fourth side 524b may be positioned at the boundary between the first region 51b and the second region 52b. Both ends of the first side 521b are connected to one end of the second side 522b and one end of the fourth side 524b, respectively. Both ends of the third side 523b are connected to the other end of the second side 522b and the other end of the fourth side 524b, respectively. The first side 521b faces the third side 523b. The second side 522b faces the fourth side 524b.

If the substrate 40 is disposed on the reinforcing member 50b, the first region 51b may face one surface of the substrate 40 in the optical axis OA direction. If the substrate 40 is disposed on the reinforcing member 50b, the second region 52b may face the opening 41 in the optical axis OA direction. Accordingly, when the image sensor 30 is not present, the second region 52b may be exposed through the opening 41. And when the image sensor 30 is connected to the substrate 40, the image sensor 30 may be disposed in the second region 52b.

The rigid reinforcing portion 500b may be positioned in the second region 52b. The rigid reinforcing portion 500b may include a plurality of rigid reinforcing lines 501b.

The rigid reinforcing line 501b may have a straight-line structure. The plurality of rigid reinforcing lines 501b may be positioned to intersect each other at at least one point. For example, the longitudinal direction of the rigid reinforcing line 501b may be provided parallel to one side of the second region 52b. That is, the longitudinal direction of the rigid reinforcing line 501b may be provided parallel to the first side 521b. Additionally, the longitudinal direction of the rigid reinforcing line 501b may be provided parallel to the second side 522b. Additionally, the rigid reinforcing line 501b may pass through the central region of the second region 52b. Additionally, two rigid reinforcing lines 501b may intersect each other in the central region of the second region 52b.

Additionally, both ends of the rigid reinforcing line 501b may be positioned adjacent to one side of the second region 52b. That is, the length of the rigid reinforcing line 501b may correspond to the length of one side of the second region 52b parallel to the rigid reinforcing line 501b.

The rigid reinforcing portion 500b may be recessed in the first surface 511 and may protrude from the second surface 512, similarly or identically to that described above in FIGS. 2 to 4. Additionally, the rigid reinforcing portion 500b may protrude from the first surface 511a and be recessed in the second surface 512a, similarly or identically to that described above in FIG. 5.

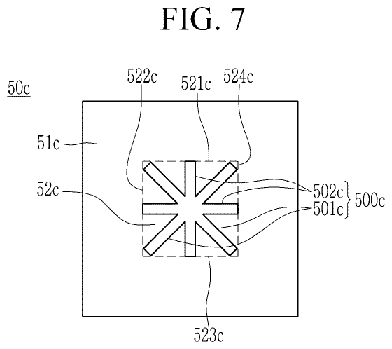

FIG. 7 is a top plan view of a reinforcing member 50c according to another embodiment.

Referring to FIG. 7, a rigid reinforcing portion 500c may be positioned on the reinforcing member 50c. The reinforcing member 50c may include a first region 51c and a second region 52c. The second region 52c may be positioned in the inner region of the first region 51c. That is, the first region 51c may be positioned on the outer periphery of the second region 52c. For example, a first side 521c, a second side 522c, a third side 523c, and a fourth side 524c may be positioned at the boundary between the first region 51c and the second region 52c. Both ends of the first side 521c are connected to one end of the second side 522c and one end of the fourth side 524c, respectively. Both ends of the third side 523c are connected to the other end of the second side 522c and the other end of the fourth side 524c, respectively. The first side 521c faces the third side 523c. The second side 522c faces the fourth side 524c.

If the substrate 40 is disposed on the reinforcing member 50c, the first region 51c may face one surface of the substrate 40 in the optical axis OA direction. If the substrate 40 is disposed on the reinforcing member 50c, the second region 52c may face the opening 41 in the optical axis OA direction. Accordingly, when the image sensor 30 is not present, the second region 52c may be exposed through the opening 41. And when the image sensor 30 is connected to the substrate 40, the image sensor 30 may be disposed in the second region 52c.

The rigid reinforcing portion 500c may be positioned in the second region 52c. The rigid reinforcing portion 500c may include a plurality of rigid reinforcing lines 501c and 502c.

The rigid reinforcing lines 501c and 502c may have a straight-line structure. The plurality of rigid reinforcing lines 501c and 502c may be positioned to intersect each other at at least one point.

The rigid reinforcing lines 501c and 502c may include a first rigid reinforcing line 501c and a second rigid reinforcing line 502c.

The longitudinal direction of the first rigid reinforcing line 501c may be provided so as to pass through the central region of the second region 52c and toward the edge of the second region 52c. That is, the longitudinal direction of the first rigid reinforcing line 501c may extend from the edge where the first side 521c and the fourth side 524c meet to the edge where the second side 522c and the third side 523c meet. Additionally, the longitudinal direction of the first rigid reinforcing line 501c may extend from the edge where the first side 521c and the second side 522c meet to the edge where the third side 523c and the fourth side 524c meet. Additionally, two first rigid reinforcing lines 501c may intersect each other in the central region of the second region 52c.

Additionally, both ends of the first rigid reinforcing line 501c may be positioned adjacent to the edges of the second region 52c. That is, the length of the first rigid reinforcing line 501c may correspond to the length of the distance between the edges of the second region 52c that face each other in a diagonal direction passing through the central region of the second region 52c.

The longitudinal direction of the second rigid reinforcing line 502c may be provided parallel to one side of the second region 52c. That is, the longitudinal direction of the second rigid reinforcing line 502c may be provided parallel to the first side 521c. Additionally, the longitudinal direction of the second rigid reinforcing line 502c may be provided parallel to the second side 522c. Additionally, the second rigid reinforcing line 502c may pass through the central region of the second region 52c. Additionally, the two second rigid reinforcing lines 502c may intersect each other in the central region of the second region 52c.

Additionally, both ends of the second rigid reinforcing line 502c may be positioned adjacent to one side of the second region 52c. That is, the length of the second rigid reinforcing line 502c may correspond to the length of one side of the second region 52c parallel to the second rigid reinforcing line 502c.

The rigid reinforcing portion 500c may be recessed in the first surface 511 and protrude from the second surface 512, similarly or identically to that described above in FIGS. 2 to 4. Additionally, the rigid reinforcing portion 500c may protrude from the first surface 511a and be recessed in the second surface 512a, similarly or identically to that described above in FIG. 5.

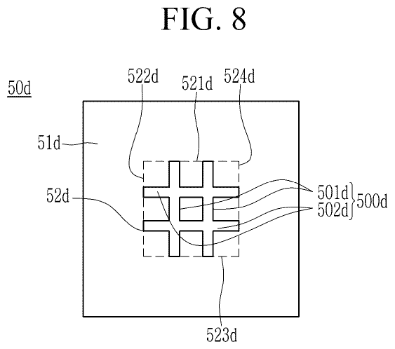

FIG. 8 is a top-plan view of the reinforcing member 50 according to another embodiment.

Referring to FIG. 8, a rigid reinforcing portion 500d may be positioned on a reinforcing member 50d. The reinforcing member 50d may include a first region 51d and a second region 52d. The second region 52d may be positioned in the inner region of the first region 51d. That is, the first region 51d may be positioned on the outer periphery of the second region 52d. For example, a first side 521d, a second side 522d, a third side 523d, and a fourth side 524d may be positioned at the boundary between the first region 51d and the second region 52d. Both ends of the first side 521d are connected to one end of the second side 522d and one end of the fourth side 524d, respectively. Both ends of the third side 523d are connected to the other end of the second side 522d and the other end of the fourth side 524d, respectively. The first side 521d faces the third side 523d. The second side 522d faces the fourth side 524d.

If the substrate 40 is disposed on the reinforcing member 50d, the first region 51d may face one surface of the substrate 40 in the optical axis OA direction. If the substrate 40 is disposed on the reinforcing member 50c, the second region 52d may face the opening 41 in the optical axis OA direction. Accordingly, when the image sensor 30 is not present, the second region 52d may be exposed through the opening 41. And when the image sensor 30 is connected to the substrate 40, the image sensor 30 may be disposed on the second region 52c.

The rigid reinforcing portion 500d may be positioned in the second region 52d. The rigid reinforcing portion 500d may include a plurality of rigid reinforcing lines 501d and 502d.

The rigid reinforcing lines 501d and 502d may have a straight-line structure. The plurality of rigid reinforcing lines 501d and 502d may be positioned to intersect each other at at least one point.

The rigid reinforcing lines 501d and 502d may include a first rigid reinforcing line 501d and a second rigid reinforcing line 502d.

The longitudinal direction of the first rigid reinforcing line 501d may be positioned to extend from the first side 521d to the third side 523d. The longitudinal direction of the first rigid reinforcing line 501d may be parallel to the second side 522d. Additionally, the longitudinal direction of the first rigid reinforcing line 501d may be inclined with respect to the second side 522d. Both ends of the first rigid reinforcing line 501d may be positioned adjacent to the first side 521d and the third side 523d, respectively.

The first rigid reinforcing line 501d is provided in plurality, and the plurality of first rigid reinforcing lines 501d may be positioned spaced apart from each other in the longitudinal direction of the first side 522d.

The longitudinal direction of the second rigid reinforcing line 502d may be positioned to extend from the second side 522d to the fourth side 524d. Accordingly, the second rigid reinforcing line 502d may intersect the first rigid reinforcing line 501d.

The longitudinal direction of the second rigid reinforcing line 502d may be parallel to the first side 521d. Additionally, the longitudinal direction of the second rigid reinforcing line 502d may be inclined with respect to the first side 521d.

Both ends of the second rigid reinforcing line 502d may be positioned adjacent to the second side 522d and the fourth side 524d, respectively.

The second rigid reinforcing line 502d is provided in plurality, and the plurality of the second rigid reinforcing lines 502d may be positioned spaced apart from each other in the longitudinal direction of the first side 522d. Accordingly, the first rigid reinforcing line 501d and the second rigid reinforcing line 502d may intersect each other to form a lattice structure. The number of second rigid reinforcing lines 502d may be the same as the number of first rigid reinforcing lines 501d.

The rigid reinforcing portion 500d may be recessed in the first surface 511 and protrude from the second surface 512, similarly or identically to that described above in FIGS. 2 to 4. Additionally, the rigid reinforcing portion 500d may protrude from the first surface 511a and be recessed in the second surface 512a, similarly or identically to that described above in FIG. 5.

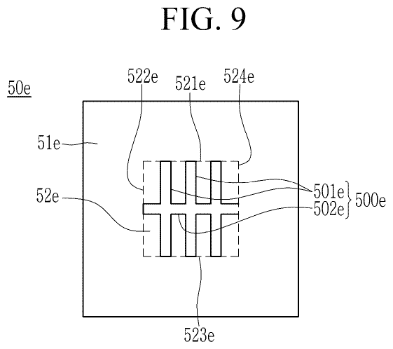

FIG. 9 is a top plan view of a reinforcing member 50e according to another embodiment.

Referring to FIG. 9, a rigid reinforcing portion 500e may be positioned on the reinforcing member 50e. The reinforcing member 50e may include a first region 51e and a second region 52e. The second region 52e may be positioned in the inner region of the first region 51e. That is, the first region 51e may be positioned on the outer periphery of the second region 52e. For example, a first side 521e, a second side 522e, a third side 523e, and a fourth side 524e may be positioned at the boundary between the first region 51e and the second region 52e. Both ends of the first side 521e are connected to one end of the second side 522e and one end of the fourth side 524e, respectively. Both ends of the third side 523e are connected to the other end of the second side 522e and the other end of the fourth side 524e, respectively. The first side 521e faces the third side 523e. The second side 522e faces the fourth side 524e.

If the substrate 40 is disposed on the reinforcing member 50e, the first region 51e may face one surface of the substrate 40 in the optical axis OA direction. If the substrate 40 is disposed on the reinforcing member 50e, the second region 52e may face the opening 41 in the optical axis OA direction. Accordingly, when the image sensor 30 is not present, the second region 52e may be exposed through the opening 41. And when the image sensor 30 is connected to the substrate 40, the image sensor 30 may be disposed in the second region 52e.

The rigid reinforcing portion 500e may be positioned in the second region 52e. The rigid reinforcing portion 500e may include a plurality of rigid reinforcing lines 501e and 502e.

The rigid reinforcing lines 501e and 502e may have a straight-line structure. The plurality of rigid reinforcing lines 501e and 502e may be positioned to intersect each other at at least one point.

The rigid reinforcing lines 501e and 502e may include a first rigid reinforcing line 501e and a second rigid reinforcing line 502e.

The longitudinal direction of the first rigid reinforcing line 501e may be positioned to extend from the first side 521e to the third side 523e. The longitudinal direction of the first rigid reinforcing line 501e may be parallel to the second side 522e. Additionally, the longitudinal direction of the first rigid reinforcing line 501e may be inclined with respect to the second side 522e. Both ends of the first rigid reinforcing line 501e may be positioned adjacent to the first side 521e and the third side 523e, respectively.

The first rigid reinforcing line 501e is provided in plurality, and the plurality of first rigid reinforcing lines 501e may be positioned spaced apart from each other in the longitudinal direction of the first side 522e.

The longitudinal direction of the second rigid reinforcing line 502e may be positioned to extend from the second side 522e to the fourth side 524e. Accordingly, the second rigid reinforcing line 502e may intersect the first rigid reinforcing line 501e.

The longitudinal direction of the second rigid reinforcing line 502e may be parallel to the first side 521e. Additionally, the longitudinal direction of the second rigid reinforcing line 502e may be inclined with respect to the first side 521e.

Both ends of the second rigid reinforcing line 502e may be positioned adjacent to the second side 522e and the fourth side 524e, respectively. The number of second rigid reinforcing lines 502e may be different from the number of first rigid reinforcing lines 501e. For example, one second rigid reinforcing line 502e may be provided. In addition, the second rigid reinforcing line 502e is provided in plurality, and the plurality of second rigid reinforcing lines 502e may be positioned spaced apart from each other in the longitudinal direction of the second side 522e. And the number of the plurality of second rigid reinforcing lines 502e may be greater than the number of the plurality of first rigid reinforcing lines 501e.

The rigid reinforcing portion 500e may be recessed in the first surface 511 and protrude from the second surface 512, similarly or identically to that described above in FIGS. 2 to 4. Additionally, the rigid reinforcing portion 500e may protrude from the first surface 511a and be recessed in the second surface 512a, similarly or identically to that described above in FIG. 5.

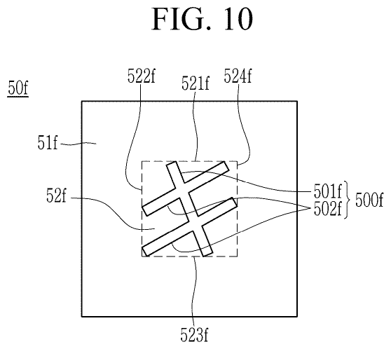

FIG. 10 is a top plan view of a reinforcing member 50f according to another embodiment.

Referring to FIG. 10, a rigid reinforcing portion 500f may be positioned on the reinforcing member 50f. The reinforcing member 50f may include a first region 51f and a second region 52f. The second region 52f may be positioned in the inner region of the first region 51f. That is, the first region 51f may be positioned on the outer periphery of the second region 52f. For example, a first side 521f, a second side 522f, a third side 523f, and a fourth side 524f may be positioned at the boundary between the first region 51f and the second region 52f. Both ends of the first side 521f are connected to one end of the second side 522f and one end of the fourth side 524f, respectively. Both ends of the third side 523f are connected to the other end of the second side 522f and the other end of the fourth side 524f, respectively. The first side 521f faces the third side 523f. The second side 522f faces the fourth side 524f.

If the substrate 40 is disposed on the reinforcing member 50f, the first region 51f may face one surface of the substrate 40 in the optical axis OA direction. If the substrate 40 is disposed on the reinforcing member 50f, the second region 52e may face the opening 41 in the optical axis OA direction. Accordingly, when the image sensor 30 is not present, the second region 52f may be exposed through the opening 41. And when the image sensor 30 is connected to the substrate 40, the image sensor 30 may be disposed in the second region 52f.

The rigid reinforcing portion 500f may be positioned in the second region 52f. The rigid reinforcing portion 500f may include a plurality of rigid reinforcing lines 501f and 502f.

The rigid reinforcing lines 501f and 502f may have a straight-line structure. The plurality of rigid reinforcing lines 501f and 502f may be positioned to intersect each other at at least one point.

The rigid reinforcing lines 501f and 502f may include a first rigid reinforcing line 501f and a second rigid reinforcing line 502f.

The longitudinal direction of the first rigid reinforcing line 501f may be positioned to extend from the first side 521f to the third side 523f. The longitudinal direction of the first rigid reinforcing line 501f may be parallel to the second side 522f. Additionally, the longitudinal direction of the first rigid reinforcing line 501f may be inclined with respect to the second side 522f. Both ends of the first rigid reinforcing line 501f may be positioned adjacent to the first side 521e and the third side 523e, respectively.

The first rigid reinforcing line 501f is provided in plurality, and the plurality of first rigid reinforcing lines 501f may be positioned spaced apart from each other in the longitudinal direction of the first side 522f. In FIG. 10, a case with one first rigid reinforcing line 501f is illustrated.

The longitudinal direction of the second rigid reinforcing line 502f may be provided to be inclined with respect to the longitudinal direction of the first rigid reinforcing line 501f. Accordingly, the second rigid reinforcing line 502f may intersect the first rigid reinforcing line 501f.

Additionally, the longitudinal direction of the second rigid reinforcing line 502f may be inclined with respect to the first side 521f. One end of the second rigid reinforcing line 502f may be provided so as to face the edge of the second region 52f.

Each end of the second rigid reinforcing line 502f may be positioned adjacent to one side of the second region 52f and one of the edges of the second region 52f. That is, both ends of the second rigid reinforcing line 502f may be positioned adjacent to the second side 522f and the edge where the first side 521f and the fourth side 524f meet, respectively. Additionally, both ends of the second rigid reinforcing line 502f may be positioned adjacent to the fourth side 524f and the edge where the second side 522f and the third side 523f meet, respectively.

The number of second rigid reinforcing lines 502f may be different from the number of first rigid reinforcing lines 501f. Additionally, the number of second rigid reinforcing lines 502f may be the same as the number of first rigid reinforcing lines 501f.

For example, one second rigid reinforcing line 502f may be provided. In addition, the second rigid reinforcing line 502f is provided in plurality, and the plurality of second rigid reinforcing lines 502f may be positioned spaced apart from each other in the longitudinal direction of the second side 522f. And the number of the plurality of second rigid reinforcing lines 502f may be greater than the number of the plurality of first rigid reinforcing lines 501f.

The rigid reinforcing portion 500f may be recessed in the first surface 511 and protrude from the second surface 512, similarly or identically to that described above in FIGS. 2 to 4. Additionally, the rigid reinforcing portion 500f may protrude from the first surface 511a and be recessed in the second surface 512a, similarly or identically to that described above in FIG. 5.

In one or more embodiments, a camera module may have a reduced risk of damage due to an external force.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module, comprising:
a lens barrel;
an image sensor disposed on one side of the lens barrel in an optical axis direction of the lens barrel;
a substrate electrically connected to the image sensor; and
a reinforcing member, comprising a rigid reinforcing portion, disposed to support the substrate,
wherein the rigid reinforcing portion comprises a plurality of rigid reinforcing lines intersecting each other at at least one point.

2. The camera module of claim 1, wherein
the reinforcing member further comprises
a first region, and
a second region disposed in a central region of the first region, and
wherein the rigid reinforcing portion is disposed in the second region.

3. The camera module of claim 2, wherein
a longitudinal direction of the plurality of rigid reinforcing lines passes through a central region of the second region and faces an edge of the second region.

4. The camera module of claim 2, wherein
the longitudinal direction of the plurality of rigid reinforcing lines is disposed parallel to one side of a boundary between the first region and the second region.

5. The camera module of claim 4, wherein
two of the plurality of rigid reinforcing lines intersect each other in a central region of the second region.

6. The camera module of claim 2, wherein
the plurality of rigid reinforcing lines comprises
a first rigid reinforcing line in which the longitudinal direction passes through a central region of the second region and faces an edge of the second region, and
a second rigid reinforcing line in which the longitudinal direction is disposed parallel to one side of the second region.

7. The camera module of claim 6, wherein
the second rigid reinforcing line comprises a plurality of second rigid reinforcing lines disposed to intersect each other in the central region of the second region.

8. The camera module of claim 2, wherein
the plurality of rigid reinforcing lines comprises
a first rigid line in which the longitudinal direction from a first side of the second region to a third side of the second region faces the first side, and
a second rigid line in which the longitudinal direction from a second side of the second region to a fourth side of the second region faces the second side.

9. The camera module of claim 2, wherein
the plurality of rigid reinforcing lines comprises
a first rigid line in which the longitudinal direction from a first side of the second region to a third side of the second region faces the first side, and
a second rigid line in which the longitudinal direction is inclined with respect to the longitudinal direction of the first rigid reinforcing line, and one end of the longitudinal direction of the second rigid line faces an edge of the second region.

10. The camera module of claim 2, wherein
an opening extends from a surface in the central region of the substrate facing the second region in the direction of the optical axis.

11. A camera module, comprising:
a lens barrel;
an image sensor disposed on one side of the lens barrel in an optical axis direction of the lens barrel;
a substrate electrically connected to the image sensor; and
a reinforcing member, comprising a rigid reinforcing portion, disposed to support the substrate,
wherein the rigid reinforcing portion is recessed away from the substrate, and a thickness of the reinforcing member corresponds to a thickness of the rigid reinforcing portion and other regions of the reinforcing member.

12. The camera module of claim 11, wherein
the rigid reinforcing portion comprises a plurality of rigid reinforcing lines intersecting each other at at least one point.

13. A camera module, comprising:
a lens barrel;
an image sensor disposed on one side of the lens barrel in an optical axis direction of the lens barrel;
a substrate electrically connected to the image sensor; and
a reinforcing member, comprising a rigid reinforcing portion, disposed to support the substrate,
wherein the rigid reinforcing portion protrudes toward the substrate more than an adjacent region, and a thickness of the reinforcing member corresponds to a thickness of the rigid reinforcing portion and other regions of the reinforcing member.

14. The camera module of claim 13, wherein
the rigid reinforcing portion comprises a plurality of rigid reinforcing lines intersecting each other at at least one point.
